(19) United States
(12) Patent Application Publication
(10) Pub. No.: US 2025/0130342 A1
(43) Pub. Date: Apr. 24, 2025

(54) Marine Seismic Survey Designs for Shallow Subsurface Investigations

(71) Applicant: PGS Geophysical AS, Oslo (NO)

(72) Inventors: Okwudili Orji, Oslo (NO); Julien Oukili, Oslo (NO); Martin Widmaier, Oslo (NO)

(73) Assignee: PGS Geophysical AS, Oslo (NO)

(21) Appl. No.: 18/917,771

(22) Filed: Oct. 16, 2024

Related U.S. Application Data
(60) Provisional application No. 63/545,073, filed on Oct. 20, 2023.

(51) Int. Cl. G01V 1/38; G01V 1/137

(52) U.S. Cl. CPC G01V 1/3843; G01V 1/137

(57) ABSTRACT

In survey configurations for towed streamer shallow target investigations, seismic sources are placed in one or more of several zones disposed at different inline offsets relative to the streamers. In some embodiments, a vessel tows a set of one or more streamers along with a set of one or more sources disposed aft of the tail end of the streamers. In other embodiments, a vessel tows a set of one or more streamers, a set of one or more near offset sources disposed forward of the front end of the streamers, and a set of one or more far offset sources disposed forward of the near offset sources.

### CROSS-REFERENCE TO RELATED APPLICATIONS

This application claims benefit to the filing date of U.S. Provisional Patent Application No. 63/545,073, filed on 2023 Oct. 20 (the “Provisional Application”), the contents of which are hereby incorporated by reference as if entirely set forth herein. In the event of conflict between the meaning of a term used in this document and the same or a similar term used in the Provisional Application or in another document incorporated herein by reference, the meaning associated with this document shall control.

### BACKGROUND

Marine seismic surveys are performed in large bodies of water to gain information about geological features that are disposed beneath the water bottom. Such surveys are performed for a variety of purposes. Some surveys, for example, are performed to identify locations of hydrocarbon reservoirs or to determine changes in properties of such reservoirs. Other surveys, sometimes referred to as site surveys or shallow target surveys, are performed to assess the suitability of a site for the installation of structures such as wind turbines, pipelines, or cables, or to inspect existing installations.

Seismic surveys that are performed to image hydrocarbon reservoirs are typically designed for targets that are disposed at substantial depths, on the order of 500 meters to several thousand meters below the water bottom. Site surveys, however, seek to image much shallower targets. For example, in a typical site investigation survey, subsurface features between about 0 and 500 meters below the water bottom (“shallow targets”) are of interest because such features can influence the locations and the foundation designs for structures to be installed at the site.

Although towed streamers may be used in shallow target surveys just as they are for deeper target surveys, the streamers used for shallow target surveys may be much shorter than their deep target counterparts. For example, streamers used for a drilling rig site survey may be on the order of 600 meters to 1200 meters in length, while streamers used for a wind turbine site survey often may be ever shorter, on the order of 25 meters to 500 meters in length, due to the typically shallower depths of wind turbine installations. Persons having skill in the art and having reference to this disclosure will appreciate that other streamer lengths may be used for either type of survey depending on the nature of and the depth of the site being investigated.

Similarly, although air guns and marine vibrators may be used in shallow target surveys just as they are for deeper target surveys, seismic sources used in shallow target surveys may also include sparkers and boomers. Like air gun sources, sparker sources and boomer sources produce a pressure impulse in the water responsive to an activation pulse, but they do so by different mechanisms. In the case of a sparker source, the activation pulse causes multiple sparks to be generated simultaneously between respective spark gaps disposed in the water. The sparks produce transient vapor bubbles, which in turn produce a pressure impulse in the water. In the case of a boomer source, which resembles an audio loudspeaker, the activation pulse causes a diaphragm in the source to move abruptly. For boomer sources, it is the movement of the diaphragm that produces the pressure impulse in the water.

### BRIEF DESCRIPTION OF THE DRAWINGS

FIGS. 1 and 2 are top and side views, respectively, illustrating an example towed streamer marine seismic survey in accordance with embodiments.

FIGS. 3-5 are block diagrams schematically illustrating example groupings of seismic sensors in accordance with embodiments.

FIG. 6 is a schematic diagram illustrating several types of offsets in marine seismic surveys in accordance with embodiments.

FIG. 7 is a block diagram illustrating an example computing device that may be used in conjunction with methods in accordance with embodiments.

FIG. 8 is a top view illustrating a variety of towed streamer survey configurations in which seismic sources are disposed in one or more of several zones disposed at different inline offsets relative to the streamers, in accordance with embodiments.

FIGS. 9-13 are top views illustrating example towing configurations in which at least one source is deployed in at least one of the aft zones of FIG. 8, in accordance with embodiments.

FIGS. 14-17 are top views illustrating example towing configuration in which at least one source is deployed in each of the forward zones of FIG. 8, in accordance with embodiments.

### DETAILED DESCRIPTION

This disclosure describes multiple embodiments by way of example and illustration. It is intended that characteristics and features of all described embodiments may be combined in any manner consistent with the teachings, suggestions, and objectives contained herein. Thus, phrases such as “in an embodiment,” “in one embodiment,” and the like, when used to describe embodiments in a particular context, are not intended to limit the described characteristics or features only to the embodiments appearing in that context.

The phrases “based on” or “based at least in part on” refer to one or more inputs that can be used directly or indirectly in making some determination or in performing some computation. Use of those phrases herein is not intended to foreclose using additional or other inputs in making the described determination or in performing the described computation. Rather, determinations or computations so described may be based either solely on the referenced inputs or on those inputs as well as others. The phrase “configured to” as used herein means that the referenced item, when operated, can perform the described function. In this sense, an item can be “configured to” perform a function even when the item is not operating and therefore is not currently performing the function. Use of the phrase “configured to” herein does not necessarily mean that the described item has been modified in some way relative to a previous state.

“Coupled” as used herein refers to a connection between items. Such a connection can be direct, or can be indirect, such as through connections with other intermediate items. Terms used herein such as “including,” “comprising,” and their variants, mean “including but not limited to.” Articles of speech such as “a,” “an,” and “the” as used herein are intended to serve as singular as well as plural references except where the context clearly indicates otherwise.

Modifiers such as “about,” “approximately,” “substantially,” and the like mean “within plus or minus 10%” of the quantity they modify.

### Marine Seismic Surveys Generally

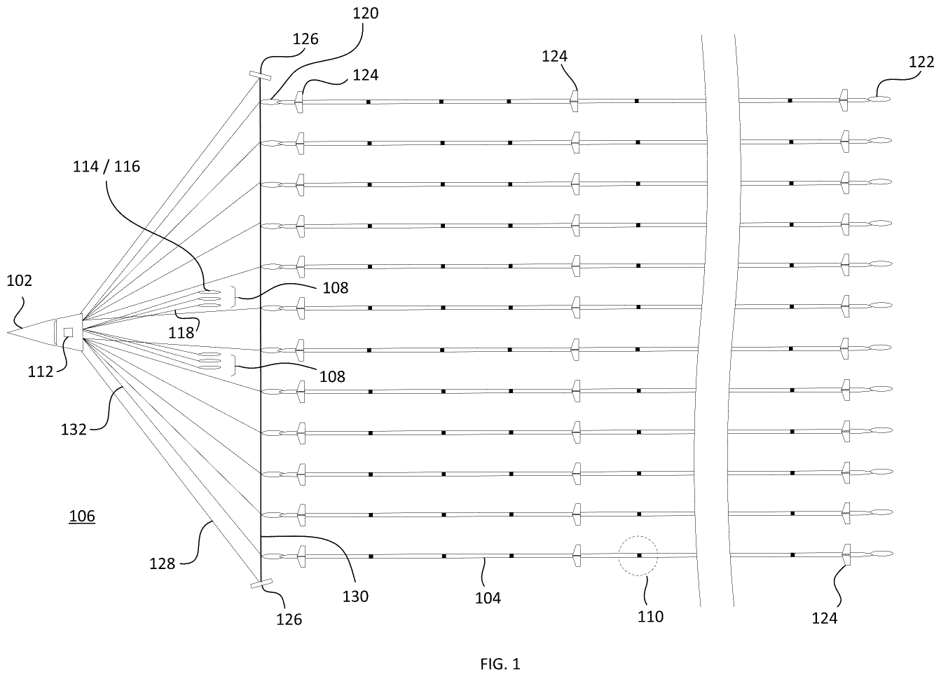

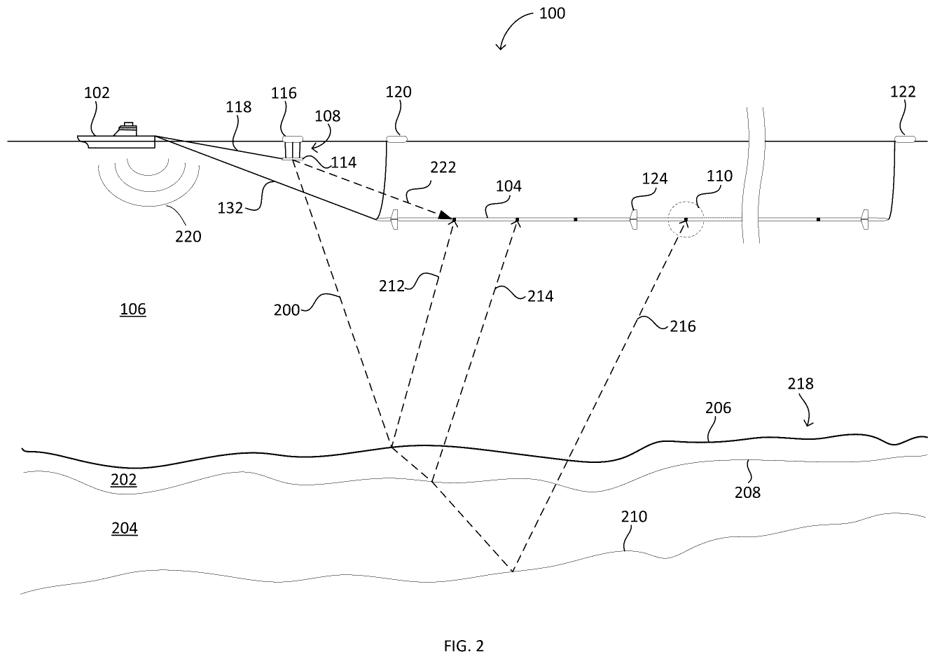

FIGS. 1 and 2 present top and side elevation views, respectively, of an example towed-streamer marine seismic survey system that employs controlled seismic sources. Survey system 100 is representative of a variety of similar geophysical survey systems in which a vessel 102 tows an array of elongate sensor streamers 104 in a body of water 106 such as an ocean, a sea, a bay, or a large lake. Typically the vessel is equipped with at least one global positioning system (“GPS”) unit so that its location during the survey may be known and recorded for later use. Vessel 102 is shown towing twelve streamers 104 in the illustrated example. In other embodiments, any number of streamers may be towed, from as few as one streamer to as many as twenty or more. The terms “streamer” and “cable” as used herein should be interpreted to include any type of seismic sensor cable, and the two terms may be used interchangeably below.

During a typical marine seismic survey, one or more controlled seismic sources 108 are activated to produce acoustic energy 200 that propagates in body of water 106. Energy 200 penetrates various layers of sediment and rock 202, 204 underlying body of water 106. As it does so, it encounters interfaces 206, 208, 210 between materials having different physical characteristics, including different acoustic impedances. At each such interface, a portion of energy 200 is reflected upward while another portion of the energy is refracted downward and continues toward the next lower interface, as shown. Reflected energy 212, 214, 216 is detected by sensors 110 disposed at intervals along the lengths of streamers 104, along with a so-called direct wavefield that reaches the sensors via a path, such as path 222, that travels directly from the controlled sources 108 to the location of the sensors. In FIGS. 1 and 2, sensors 110 are indicated as black squares inside each of streamers 104. Sensors 110 produce signals corresponding to the reflected energy. These signals are collected and recorded by control equipment 112 located onboard vessel 102. The recorded signals may be processed and analyzed onboard vessel 102 and/or at one or more onshore data centers to produce images of structures within subsurface 218. These images can be useful, for example, in identifying possible locations of hydrocarbon reservoirs within subsurface 218 or in assessing the suitability of sites for the installation of offshore structures.

Any number of controlled sources 108 may be used in a marine seismic survey. In the illustrated example, vessel 102 is shown towing two such sources. In other systems, different numbers of sources may be used, and the sources may be towed by other vessels, which vessels may or may not tow additional streamer arrays. Typically, a controlled source 108 includes one or more source subarrays 114, and each subarray 114 includes one or more acoustic emitters such as air guns, sparkers, boomers, or marine vibrators. Each subarray 114 may be suspended at a desired depth from a subarray float 116. Compressed air and/or electrical power and control signals may be communicated to each subarray via source umbilical cables 118. Data may be collected, also via source umbilical cables 118, from various sensors located on subarrays 114 and/or floats 116, such as acoustic transceivers and GPS units. Acoustic transceivers and GPS units so disposed help to accurately determine the positions of each subarray 114 during a survey.

In some marine seismic surveys, streamers 104 are very long—on the order of 5 to 10 kilometers—so are constructed by coupling numerous shorter streamer sections together. In other marine seismic surveys, such as those used to assess sites for the installation of offshore structures, the streamers may be relatively short—on the order of 100 meters in length, for example.

In any such surveys, each streamer 104 may be attached to a dilt float 120 at its proximal end (the end nearest vessel 102) and to a tail buoy 122 at its distal end (the end farthest from vessel 102). Dilt floats 120 and tail buoys 122 may be equipped with GPS units as well to help determine the positions of each streamer 104 relative to an absolute frame of reference such as the earth. Each streamer 104 may in turn be equipped with acoustic transceivers and/or compass units to help determine their positions between GPS units and/or relative to one another. In many survey systems 100, streamers 104 include steering devices 124 attached at intervals, such as every 300 meters. Steering devices 124 typically provide one or more control surfaces to enable moving the streamer to a desired depth, or to a desired lateral position, or both. Paravanes 126 are shown coupled to vessel 102 via tow ropes 128. As the vessel tows the equipment, paravanes 126 provide opposing lateral forces that straighten a spreader rope 130, to which each of streamers 104 is attached at its proximal end. Spreader rope 130 helps to establish a desired crossline spacing between the proximal ends of the streamers. Power, control, and data communication pathways are housed within lead-in cables 132, which couple the sensors and control devices in each of streamers 104 to the control equipment 112 onboard vessel 102.

Collectively, the array of streamers 104 forms a sensor surface at which acoustic energy is received for recording by control equipment 112. In many instances, it is desirable for the streamers to be maintained in a straight and parallel configuration to provide a sensor surface that is generally flat, horizontal, and uniform. In other instances, an inclined and/or fan shaped receiving surface may be desired and may be implemented using control devices on the streamers such as those just described. Other array geometries may be implemented as well. Prevailing conditions in body of water 106 may cause the depths and lateral positions of streamers 104 to vary at times, of course. In various embodiments, streamers 104 need not all be the same length and need not all be towed at the same depth or with the same depth profile.

Sensors 110 within each streamer 104 may include one or more different sensor types such as pressure sensors (e.g., hydrophones) and/or motion sensors. Examples of motion sensors include velocity sensors (e.g., geophones) and acceleration sensors (e.g., accelerometers) such as micro-electromechanical system (“MEMS”) devices. In general, pressure sensors provide a magnitude-only, or scalar, measurement. This is because pressure is not associated with a direction and is therefore a scalar quantity. Motion sensors such as velocity sensors and acceleration sensors, however, each provide a vector measurement that includes both a magnitude and, at least implicitly, a direction, as velocity and acceleration are both vector quantities. Velocity sensors and acceleration sensors each may be referred to herein as “motion sensors.”

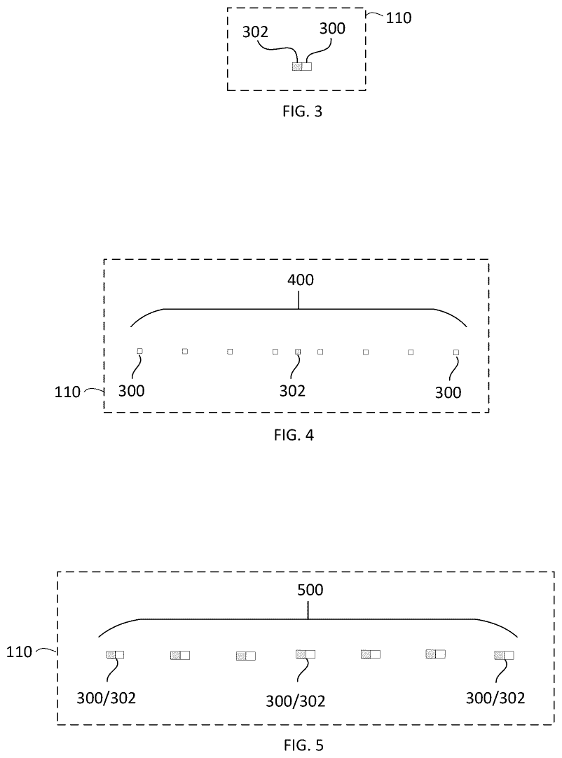

FIGS. 3, 4 and 5 illustrate several example arrangements consistent with embodiments for disposing sensors 110 in a streamer or cable 104 or in an ocean bottom node or an ocean bottom cable. In each illustration, pressure sensors are indicated with white squares, while motion sensors are indicated with shaded squares.

In the arrangement of FIG. 3, each sensor location 110 comprises a single pressure sensor 300 collocated with a single motion sensor 302. In the arrangement of FIG. 4, each sensor location 110 comprises a set of pressure sensors 300 forming a single pressure sensor group 400. A motion sensor 302 is disposed substantially at the center of pressure sensor group 400. (It is also possible to employ a similar arrangement in which a single pressure sensor is disposed among a group of motion sensors.) Typically, the signals generated by sensors forming a sensor group are combined or aggregated in some way, such as by summation and/or averaging. Such combination or aggregation may be accomplished in any suitable manner, such as in an analog domain using appropriate electrical coupling, or in a digital domain using digital data processing. In general, a sensor group may include any number of sensors and may comprise either pressure sensors or motion sensors. Normally, however, only measurements of the same type in a group (e.g., pressure, velocity, or acceleration) would be subject to combination or aggregation. Thus, in the particular arrangement illustrated in FIG. 4, the measurements of pressure sensors 300 may be combined or aggregated into a single signal, while the measurements of motion sensor 302 would be preserved as a separate signal. In the arrangement of FIG. 5, each sensor location 110 comprises a group 500 of collocated pressure sensors 300 and motion sensors 302. In the latter arrangement, one aggregated signal can be generated from the pressure sensors in the group, while another aggregated signal can be generated from the motion sensors in the group. Various other permutations of the arrangements of FIGS. 3, 4 and 5 are also possible. For example, any of these arrangements may comprise pressure sensors only or motion sensors only.

### Offsets in Marine Seismic Surveys

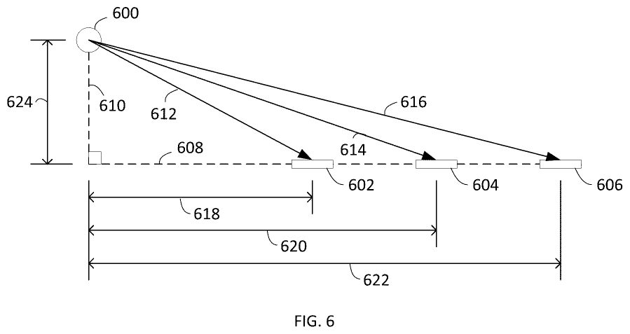

FIG. 6 is provided to illustrate the concept of offset in marine seismic surveys. In the figure, circle 600 represents a source, while each of rectangles 602, 604, 606 represents a sensor or sensor group. For example, sensors or sensor groups 602-606 may represent sensors disposed along the length of a single streamer 104, or may represent sensors in distinct ocean bottom nodes or sensors disposed within an ocean bottom cable. Dashed line 608 depicts an inline direction. Dashed line 610 depicts a crossline direction orthogonal to the inline direction. Typically, a vessel towing a source would follow a sail path parallel to inline direction 608.

The distance between a source and any one sensor or sensor group constitutes an offset. Such an offset may be measured from the source to a single sensor, or to any one of the sensors within a sensor group, or to the center of a sensor group. Three different example offsets are illustrated in the drawing, ranging in length from a smallest offset 612, to an intermediate length offset 614, to a largest offset 616. A distance along the straight line path between a source and a given sensor or sensor group, as depicted by arrows 612-616, is commonly referred to as a “seismic offset” or simply an “offset.” A distance along direction 608 between a source and the inline projection of a sensor or sensor group is commonly referred to as an “inline offset.” Thus, sensor or sensor group 602 defines a smallest inline offset 618 with respect to source 600, sensor or sensor group 604 defines an intermediate length inline offset 620 with respect to the source, and sensor or sensor group 606 defines a largest inline offset 622 with respect to the source. Similarly, a distance along direction 610 between a sensor or sensor group and the crossline projection of the source is commonly referred to as a “crossline offset.” In the illustrated example, each of sensors or sensor groups 602-606 defines the same crossline offset 624 with respect to source 600.

The term “offset” as used herein refers to any of the above-described distances.

### Example Computer System

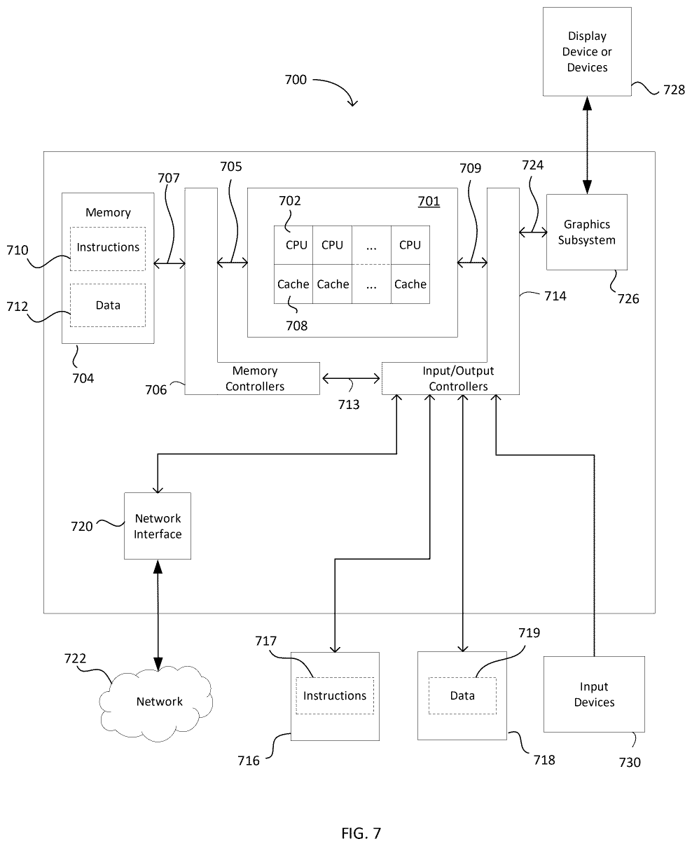

FIG. 7 is a block diagram logically illustrating an example computer system 700 that may be used in conjunction with embodiments and/or to perform any of the methods described herein. Persons having skill in the art and having reference to this disclosure will appreciate that suitable computer system architectures may vary and that alternative or additional types of computing devices may also be employed in conjunction with any of the embodiments described herein. Computer system 700 is therefore shown by way of example and not by way of limitation.

Computer system 700 includes a core/cache complex 701 that contains one or more central processor unit (“CPU”) cores 702, each of which is associated with one or more levels of high-speed cache memory 708. The core/cache complex is in turn coupled to one or more high-speed memory controllers 706, as indicated at 705, and to one or more input/output controllers 714, as indicated at 709. The memory controllers and the input/output controllers may additionally be coupled to one another via one or more high-speed interconnects 713.

The memory controllers may be coupled to a system memory 704 by any suitable means, such as via a high-speed memory bus 707. The memory controllers facilitate interactions between the system memory and the core/cache complex as well as between the system memory and the input/output controllers. System memory 704 typically comprises a large array of random-access memory locations, often housed in multiple dynamic random-access memory (“DRAM”) devices, which in turn may be housed in one or more dual inline memory module (“DIMM”) packages., as shown. Each core 702 can execute computer-readable instructions 710 stored in the system memory, and can thereby perform operations on data 712, also stored in the system memory.

The input/output controllers may be coupled to respective subsystems as indicated in the drawing. Non-limiting examples of such subsystems include a graphics subsystem 726, a network interface 720, one or more non-transitory computer-readable media such as computer-readable medium 716 and computer-readable medium 718, and one or more input devices 730.

Network interface 720 may facilitate interactions between components of the computer system and an external network 722. Non-limiting examples of network 722 include a local area network, a wide area network, the internet, or any combination of these.

Non-limiting examples of non-transitory computer-readable media include so-called solid-state disks (“SSDs”), spinning-media magnetic disks, optical disks, flash drives, magnetic tape, and the like. The storage media may be permanently attached to the computer system or may be removable and portable. In the example shown, medium 716 has instructions 717 (software) stored therein, while medium 718 has data 719 stored therein. Operating system software executing on the computer system may be employed to enable a variety of functions, including transfer of instructions 710, 717 and data 712, 719 back and forth between the storage media and the system memory.

In embodiments that include a graphics subsystem, one or more of the input/output controllers may be coupled to the graphics subsystem by any suitable means, such as by a high-speed bus 724. The graphics subsystem may in turn be coupled to one or more display devices 728. While display devices 728 may be located in physical proximity to the rest of the components of the computer system, they may also be remotely located. Software running on the computer system may generate instructions or data that cause graphics subsystem to display any of the example user interface elements described above on display devices 728. Such software may also generate instructions or data that cause the display of such elements on one or more remotely located display devices (for example, display devices attached to a remotely located computer system) by sending the instructions or data over network 722 using an appropriate network protocol. The graphics subsystem may comprise one or more graphics processing units (“GPUs”) to accelerate the execution of instructions or to implement any of the methods described above.

Computer system 700 may represent a single, stand-alone computer workstation that is coupled to input/output devices such as a keyboard, pointing device and display. It may also represent one of the nodes in a larger, multi-node or multi-computer system such as a cluster, in which case access to its computing capabilities may be provided by software that interacts with and/or controls the cluster. Nodes in such a cluster may be co-located in a single data center or may be distributed across multiple locations or data centers in distinct geographic regions. Furthermore, computer system 700 may represent an access point from which such a cluster or multi-computer system may be accessed and/or controlled. Any of these or their components or variants may be referred to herein as “computing apparatus,” a “computing device,” or a “computer system.”

In example embodiments, data 719 may correspond to sensor measurements or other data recorded during a marine geophysical survey or may correspond to a survey plan for implementing any of the surveys described herein. Instructions 717 may correspond to instructions for performing any of the methods described herein. In such embodiments, instructions 717, when executed by one or more computing devices such as one or more of CPU cores 702, cause the computing device to perform operations described herein on the data, producing results that may be stored in one or more tangible, non-volatile, computer-readable media such as medium 718. In such embodiments, medium 718 constitutes a geophysical data product that is manufactured by using the computing device to perform methods described herein and by storing the results in the medium. Geophysical data product 718 may be stored locally or may be transported to other locations where further processing and analysis of its contents may be performed. If desired, a computer system such as computer system 700 may be employed to transmit the geophysical data product electronically to other locations via a network interface 720 and a network 722 (e.g., the Internet). Upon receipt of the transmission, another geophysical data product may be manufactured at the receiving location by storing contents of the transmission, or processed versions thereof, in another tangible, non-volatile, computer readable medium. Similarly, geophysical data product 718 may be manufactured by using a local computer system 700 to access one or more remotely-located computing devices in order to execute instructions 717 remotely, and then to store results from the computations on a medium 718 that is attached either to the local computer or to one of the remote computers. The word “medium” as used herein should be construed to include one or more of such media.

### Example Embodiments

Numerous embodiments will now be described, by way of example and not limitation, with reference to FIGS. 8-17. The numbers and types of streamers and sources used in various embodiments may vary from those shown and described in the examples. For example, streamers used in embodiments may comprise any one or more types of seismic sensors including, without limitation, pressure sensors and/or motion sensors. Moreover, embodiments may employ any one or more types of seismic sources including, without limitation, sparkers, boomers, air guns, marine vibrators, or any combinations of these.

In any embodiments, streamers in the streamer spread may be towed at the same depth or at different depths. Moreover, one or more of the streamers may be towed with one or more inline depth gradients along the length of the streamer. Source depths may also vary depending on the source type and the survey requirements. Sparker sources, for example, are typically towed at depths between about 20 cm to about 60 cm, while boomers are typically towed at depths of about 30 cm to about 1 meter, and air guns at depths between about 2 meters and about 15 meters. Other source types and towing depths may be used in various embodiments as needed or desired.

### Source Locations

Numerous benefits may be achieved during towed streamer shallow target investigations by disposing seismic sources in one or more of several zones disposed at different inline offsets relative to the streamers. FIG. 8 helps to illustrate this.

In the drawing, a single marine vessel 800 tows a streamer spread 802 and at least one set of one or more sources. Arrow 814 indicates a forward direction (the direction of tow), while arrow 816 indicates an aft direction (opposite the direction of tow). In the embodiment shown, the vessel tows an even number of streamers, and the centerline 801 of the vessel is centered between two crossline innermost ones of the streamers, 803 and 805. In other embodiments, the vessel may tow an odd number of streamers, and a single innermost streamer may be towed inline with the centerline of the vessel. In still other embodiments the streamer spread may be towed asymmetrically, with a crossline offset relative to the centerline of the vessel. In the embodiment of FIG. 8, all of the streamers in the streamer spread have the same length L. In other embodiments, the streamers may have unequal lengths.

Several possible inline source zones are indicated generally at 804, 806, 808, 810, and 812. In various embodiments, a given one of the zones may include zero, one, or multiple sources. When multiple sources occupy a given zone, the sources may be towed with a crossline offset relative to one another within the given zone. In the latter case, not all of the sources in the zone need be towed at the same inline position. In some embodiments, the forward ends of the streamers in the spread may define a curved arc as they are towed, and the sources in a given zone may be disposed along the same curved arc.

A forward-most one of the sensors disposed closest to the centerline of the vessel defines a front end 818 of the streamer spread, while an aft-most one of the sensors disposed closest to the centerline of the vessel defines a tail end 820 of the streamer spread. In the illustrated embodiment, the inline distance between the front end of the streamer spread and the tail end of the streamer spread defines a streamer length L.

Sources disposed in zones 806 and/or 810 are intended to produce near offset data. Thus, as can be seen in the drawing, each of zones 806 and 810 is disposed less than one streamer length L from a respective end of the streamer spread. Specifically, zone 806 is disposed less than one streamer length L forward of the front end of the streamer spread, while zone 810 is disposed less than one streamer length L aft of the tail end of the streamer spread. Depending on the near offsets desired, in some embodiments each of zones 806 and 810 may be disposed within about 20 inline meters from the respective end of the streamer spread. In other embodiments, each of zones 806 and 810 may be disposed at an inline distance from the respective end of the streamer spread such that the distance is less than or equal to about 40% of the length of the shortest streamer in the spread. Other inline distances from the streamer spread may also be used for near offset zones 806 and/or 810.

Sources disposed in zones 804 and/or 812 are intended to produce long offset data. Thus, in the illustrated embodiment, each of zones 804 and 812 is disposed at least one streamer length L from a respective end of the streamer spread. Specifically, zone 804 is disposed at least one streamer length L forward of the front end of the streamer spread, while zone 812 is disposed at least one streamer length L aft of the tail end of the streamer spread. Depending on the far offsets desired and the source separation benefits sought, different inline distances may also be used, as will be further discussed below.

Zone 808 is disposed at an inline position within the inline extent of the streamer spread. That is, zone 808 may be disposed at one or more inline positions between the front end of the streamer spread and the tail end of the streamer spread, and at one or more crossline positions between a starboard-most one of the streamers and a port-most one of the streamers. In some embodiments, zone 808 may be located at the inline center of the streamer spread, as shown.

In various embodiments, sources may be towed in any combination of zones 804, 806, 808, 810, 812, including in all of the zones--provided that streamer length L is such that tow lines and any necessary control and/or supply lines associated with the aft-most sources are able to extend to the sources and remain functional. It is currently believed that this will be possible at least for embodiments in which the streamer length L is less than or equal to about 200 meters. Depending on the parameters of a given towing configuration, longer streamer lengths than 200 meters may also be accommodated.

### Longer Offsets are Achieved

Among the benefits of towing sources in zones 804 and/or 812 are that longer offsets may be achieved relative to the towing arrangements of the prior art. For example, in conventional towing arrangements, sources are disposed in zone 806 only, and therefore the longest offsets acquired are defined by the streamer length L plus the inline offset between zone 806 and the front end of the streamer spread. When sources are towed in zones 804 and/or 812 in accordance with embodiments, however, the longest offsets acquired can be 2×L or greater. For a given survey, such longer offset data may be used to enhance the accuracy of the velocity model that is used to produce an image of subsurface features, where the image is produced using near offset data acquired from sources disposed in one or more of zones 806, 808, and 810. For example, such a velocity model may be computed using a full waveform inversion process according to known techniques. In addition, the longer offset data so acquired may be used to perform amplitude versus azimuth (“AVA”) or amplitude versus offset (“AVO”) analysis to better understand the elastic properties of the subsurface. Furthermore, the longer offset data may be used to produce an image of deeper targets than those imaged by the near offset data.

While any type of sources may be deployed in zones 804 and 812, in some embodiments, air gun sources may be deployed in those zones in order to provide lower wavefield frequencies (and thus deeper penetration into the subsurface) than sparker or boomer sources typically provide.

Note that, if an air gun source is towed too closely ahead of another source, the bubble train of the forward source could potentially interfere with the wavefield emitted by the source towed behind it. In various embodiments, this interference may be avoided by adjusting the inline distance between the air gun source and the source that follows it, or by adjusting the towing speed of the vessel, or both. It is currently believed that an inline separation of 200 meters between a forward air gun source and an aft sparker source, for example, is sufficient to avoid bubble train interference at vessel speeds that are typical for high-resolution surveys.

### Source Separation is Improved for Sources Disposed Forward and Aft of the Streamers

Among the benefits of towing sources in either of zones 804 and 806, while also towing sources in either of zones 810 and 812, is that such an arrangement improves source separation (also called de-blending) when so-called simultaneous shooting is employed. In simultaneous shooting, two or more sources are active closely enough in time with one another such that reflections from the source activations are recorded together by the receivers in a blended fashion. After the reflections are recorded together, the recorded signals are de-blended according to known techniques to separate recorded energy attributable to one source activation from recorded energy attributable to one or more different source activations.

Because zones 804 and 806 are disposed forward of the streamers and zones 810 and 812 are disposed aft of the streamers, and because sensors in the streamers are spaced apart in an inline direction along the streamers, reflected energy from the forward sources will propagate down the sensors in each streamer in the aft direction, while reflected energy from the aft sources will propagate down the sensors in each streamer in the forward direction. This phenomenon may be referred to as “orthogonal moveout.”

The phenomenon of orthogonal moveout may be exploited when energy attributable to one or more sources in zones 804 and/or 806 must be separated from energy attributable to one or more sources in zones 810 and/or 812. That is, moveout filtering may be employed to isolate forward source energy from aft source energy. While conventional techniques for separating source energy often require imposing strict timing constraints between the activations of the various sources whose energy must be de-blended, the availability of orthogonal moveout in deblending enables relaxation of such strict timing constraints between the activations of the forward and the aft sources. For example, in towing arrangements according to embodiments, the so-called “pop” intervals between activations of a forward source and activations of an aft source may be reduced, thereby increasing the number of source activations per unit time. The increase in source activations per unit time enables more data points to be gathered per unit distance and thereby contributes to increased resolution for the images produced from the survey data.

In addition, because the availability of orthogonal moveout in source de-blending allows relaxation of the timing constraints between forward and aft source activations, embodiments may employ different source controllers, if desired, to actuate the forward and the aft sources. That is, one source controller may be used to control forward sources, while another source controller may be used to control aft sources, which may provide practical advantages in the field. In other embodiments, one source controller may be used to control both the forward and the aft sources.

### Source Separation is Also Improved Between Near and Far Offset Sources

As will be further discussed below, provided that a sufficient inline distance exists between sources in zone 804 relative to sources in zone 806, the difference in arrival times associated with the sources may be utilized to improve source separation as between the two zones during de-blending. The same is true of sources disposed in zones 810 and 812.

### Denoising is Improved with Bisymmetrical Sources Forward and Aft of the Streamers

A further benefit may be achieved by disposing sources equidistant from the streamer spread in both of zones 806 and 810 and/or by disposing sources equidistant from the streamer spread in both of zones 804 and 812. Doing so creates symmetry because the sources in corresponding forward and aft zones are disposed equidistant from respective ends of the streamer spread in the inline direction. That is, when sources are placed in zones 806 and 810, the sources disposed in zone 806 would be located the same distance in front of the streamer spread as the sources disposed in zone 810 are located aft of the streamer spread. Similarly, when sources are placed equidistant from the streamer spread in zones 804 and 812, the sources disposed in zone 804 are located the same distance in front of the streamer spread as the sources disposed in zone 810 are located aft of the streamer spread. If the sources in the forward zones are also disposed at the same crossline positions as are the sources in the corresponding aft zone, then bisymmetry is created.

The resulting bisymmetry may be exploited to denoise the recorded data, thus enhancing the quality of the information acquired by the survey. According to the principle of reciprocity, in a noise-free environment, reflections recorded from a given subsurface reflector should be identical regardless of which one of the symmetrical forward and aft sources produced the reflection (after allowing for the orthogonal moveout phenomenon described above). Thus, any noise signal emanating from a location other than the center of the bisymmetry will produce a different effect on the reflections recorded from activations of the symmetrical sources. This effect can be exploited to remove such a noise signal from the recorded data by comparing the signals attributable to the forward sources with the signals attributable to the corresponding aft sources.

### Vessel Noise Removal is Improved with Sources Aft of the Streamers

Among the benefits of towing sources in either of zones 810 or 812 is that doing so improves removal of any noise in the recorded data that is attributable to emissions from tow vessel 800 or from equipment disposed thereon.

Because of the relatively close proximity of the vessel to the survey spread in conventional shallow target towing configurations, noise from the vessel in the recorded signals can be significant, and it can become problematic in conventional approaches to distinguish the vessel noise from the desired signal in the recorded data. When sources are disposed in either of zones 810 or 812 in accordance with embodiments, however, the same orthogonal moveout phenomenon described above may be exploited to distinguish the vessel noise from the signals emitted by the sources in zones 810 and/or 812. This is because the emissions from the vessel originate from points located forward of the streamers, while emissions from the sources in zones 810 and/or 812 originate from points located aft of the streamers.

### Diffraction Imaging is Improved with Sources Within the Streamer Spread Area

In various embodiments, one or more sources may be disposed in zone 808. Among the benefits of doing so is to improve the ability to use diffracted source energy for imaging subsurface features. In particular, placing sources within the area defined by the streamer spread aids in the detection of the apex of diffraction for such energy as a step in the diffraction imaging process. In some embodiments, the process may be further aided by disposing sources at the crossline center of one or more of the streamers in the streamer spread, such that equally as many offsets forward of the sources are recorded as are recorded aft of the sources.

### Increasing CMP Coverage with Crossline Offsets Between Sources in Different Zones

The inline path followed by a source as it is towed can be referred to as a “source line.” When multiple sources are towed with crossline offsets between them, each source in the configuration will follow a different source line as determined by the crossline offsets between them. Common midpoint (“CMP”) lines are generated in the acquired data in every survey. The number of the CMP lines so generated, and their relative positions, are a function of the positions of the source lines and the positions of the towed streamers.

In some embodiments, the sources in a first zone may be configured to follow different source lines than are followed by sources in a second zone, such that one or more CMP lines are generated by the first sources and are not also generated by the second sources.

This may be accomplished in a number of ways, including by towing the first sources further starboard or further port than the sources in the second zone. In the latter embodiments, an even number of streamers may also be employed. In such a case, one of the streamers may be disposed along the centerline of the towing vessel such that the streamer spread is towed in a crossline asymmetrical manner relative to the vessel centerline. To reap the benefit of the increased CMP line coverage produced by the displaced sources, the “extra” streamer may be disposed on the side of the vessel centerline toward which the first sources are displaced.

### Long Layback Configurations Providing Longer Offsets With or Without Aft Sources

In embodiments that deploy sources in zones 804 and 806, it is possible to achieve longer offsets than are achievable with conventional towing arrangements, regardless of whether any sources are also deployed in either of aft zones 810 or 812. This is due to the “long layback” represented by the distance between the sources in zone 804 and the front end of the streamer spread. As mentioned above, in various embodiments, this distance may be equal to or greater than the streamer length L. In embodiments that employ different streamer lengths, this layback distance may be greater than or equal to the length of the shortest streamer in the streamer spread. For even greater offsets, the layback distance may be greater than or equal to the length of the longest streamer in the streamer spread.

### Example Configurations with Aft Sources

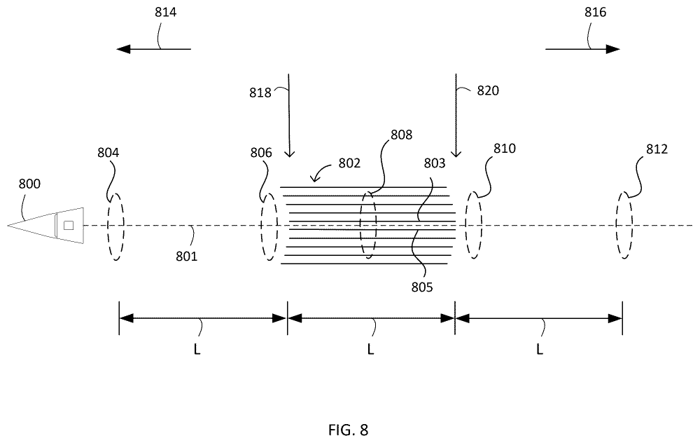

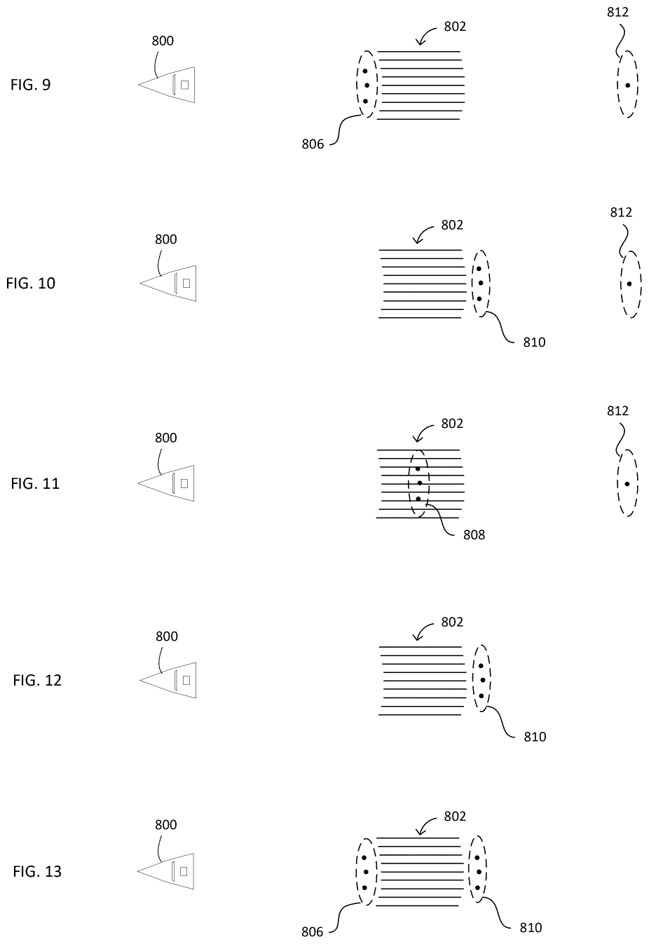

Each of FIGS. 9-13 illustrates an example towing configuration in which at least one source is deployed in at least one of aft zones 810 or 812. In all of the figures, a source is denoted by a dark circle.

In the configuration of FIG. 9, three sources are deployed in zone 806 to generate near offset data, while a single long offset source is deployed in aft zone 812. To gain the above-described source separation benefits in the configuration of FIG. 9, the sources in zone 812 may be towed aft of the tail end of the streamer spread by a distance not less than about 50% of the length of the shortest streamer in the streamer spread. In other embodiments, other distances may be used.

In the configuration of FIG. 10, three sources are deployed in aft zone 810 to generate near offset data, while a single long offset source is deployed in aft zone 812.

In the configuration of FIG. 11, three sources are deployed in zone 808 to generate near offset data for diffraction imaging, while a single long offset source is deployed in aft zone 812.

To gain the above-described source separation benefits in the configurations of FIGS. 10 and 11, the sources in zone 812 may be towed not less than about 80% of the length of the shortest streamer in the streamer spread.

In the configuration of FIG. 12, three sources are deployed in aft zone 810 only, to generate near offset data with improved removal of vessel noise as described above.

In the configuration of FIG. 13, three sources are deployed in each of forward zone 806 and aft zone 810. These sources generate near offset data and enable the attenuation of asymmetrically disposed noise sources as described above.

In all of the configurations of FIGS. 9-13, different numbers of sources may be employed in each of the respective zones than the numbers of sources illustrated, and different numbers and positions of streamers may be employed in the streamer spreads than the numbers and positions of streamers illustrated, if desired. In some embodiments, the streamer length L may be about 50 meters. In other embodiments, the streamer length L may be about 100 meters. In still other embodiments, the streamer length L may be about 200 meters. Other streamer lengths may be used as well.

### Example Configurations with Long Laybacks

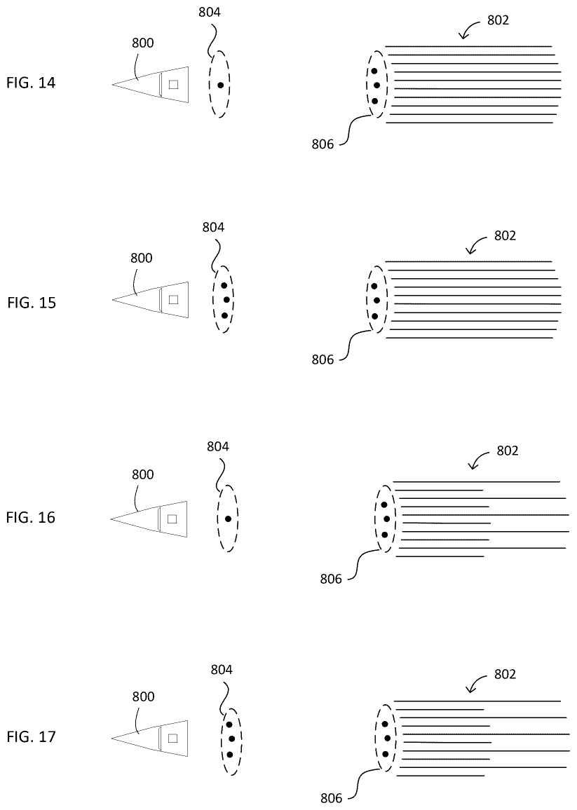

Each of FIGS. 14-17 illustrates an example towing configuration in which a long layback is employed to achieve longer offsets as described above.

In the configuration of FIG. 14, a single long offset source is deployed in zone 804, while three near offset sources are deployed in zone 806.

In the configuration of FIG. 15, three long offset sources are deployed in zone 804, and three near offset sources are deployed in zone 806.

In each of the configurations of FIGS. 14 and 15, the streamer length L may be about 50 meters, about 100 meters, or about 200 meters. Other streamer lengths may be used as well.

The configurations of FIGS. 16 and 17 are similar to those of FIGS. 14 and 15, respectively, except that a combination of longer and shorter streamers are used in the streamer spread. The longer steamers may be used to provide even longer offsets relative to those that could be achieved by only using the shorter streamers in the streamer spread. In some embodiments, the layback distance between the sources in zone 804 and the front end of the streamer spread may be equal to or greater than the length of the longer streamers.

To gain the above-described source separation benefits in the configurations of FIGS. 14 to 17, the sources in zone 804 may be towed forward of the front end of the streamer spread by a distance not less than about 80% of the length of the shortest streamer in the streamer spread. In other embodiments, other distances may be used.

In some embodiments, the longer streamers may be about 200 meters in length, while the shorter streamers may be about 100 meters in length. Other streamer lengths may be used in other embodiments.

In the embodiments shown, the longer streamers are interleaved with the shorter streamers such that at least one of the longer streamers is disposed between each pair of the shorter streamers. This arrangement provides a variety of azimuth coverage for long offset data recorded by the longer streamers even in towing configurations that deploy only a single long offset source, as in the configuration of FIG. 16. In other embodiments, other spatial dispositions of the longer streamers relative to the shorter streamers may be used. For example, in configurations that deploy three sources in zone 804, azimuth variety is created by the crossline offsets between the long offset sources themselves. In such a case, the interleaving of longer and shorter streamers may be relaxed relative to the arrangements shown in the drawings while still preserving azimuth variety in the long offset data.

In still further embodiments, the total crossline width defined by the starboard-most and port-most ones of the longer streamers may be wider than the corresponding crossline width defined by the starboard-most and port-most ones of the shorter streamers. Moreover, the crossline spacing of the longer streamers, as well as their tow depths, may be different than those of the shorter streamers. The latter arrangements may be beneficial for surveys in which the longer streamers are to be used for acquiring data at lower frequencies than the data to be acquired by the shorter streamers. In either case, the sampling densities associated with the longer and the shorter streamers may correspond to the respective frequencies of interest for each streamer set in accordance with the Nyquist criterion. Similarly, the towing depths of the two streamer sets may differ in order to accommodate different sets of ghost notches, where the ghost notches correspond to the respective frequency bands to be acquired by the two streamer sets.

### Further Example Embodiments

A non-exhaustive list of example embodiments is as follows.

1. Performing a marine seismic survey, comprising:
towing, with a vessel, a set of one or more streamers, wherein the streamers comprise one or more seismic sensors, wherein a forward-most one of the sensors disposed closest to a centerline of the vessel defines a front end of the streamers, and wherein an aft-most one of the sensors disposed closest to the center line of the vessel defines a tail end of the streamers;
towing, with the vessel, a set of one or more first sources disposed aft of the tail end of the streamers; and
recording, in a non-transitory computer-readable medium, signals generated by the seismic sensors responsive activations of the first sources.

2. The embodiment of example 1, wherein:
a shortest one of the streamers defines a streamer length; and
the first sources are disposed less than one streamer length aft of the tail end of the streamers.

3. The embodiment of example 1, wherein:
a shortest one of the streamers has a length of about 50 meters.

4. The embodiment of example 1, wherein:
a shortest one of the streamers has a length of about 100 meters.

5. The embodiment of any of examples 1-4:
further comprising towing, with the vessel, a set of one or more second sources disposed aft of the tail end of the streamers by a distance not less than about 80% of the streamer length, and farther aft than the first sources.

6. The embodiment of any of examples 1-4:
wherein a shortest one of the streamers defines a streamer length; and
further comprising towing, with the vessel, a set of one or more second sources disposed less than one streamer length forward of the front end of the streamers;
wherein the first sources are disposed aft of the tail end of the streamers by a distance not less than about 50% of the streamer length.

7. The embodiment of any of examples 1-4:
further comprising towing, with the vessel, a set of one or more second sources disposed forward of the streamers.

8. The embodiment of example 7, wherein:
an inline distance between the first sources and the tail end of the streamers is the same as an inline distance between the second sources and the front end of the streamers.

9. The embodiment of any of examples 1-4:

further comprising towing, with the vessel, a set of one or more second sources disposed at one or more inline positions between the front end of the streamers and the tail end of the streamers, and at one or more crossline positions between a starboard-most one of the streamers and a port-most one of the streamers.

10. The embodiment of any of examples 5-9, wherein:
at least one of the second sources follows a unique source line relative to source lines followed by the first sources, such that the second sources generate at least one common midpoint (“CMP”) line in the recorded signals that is not also generated by the first sources.

11. The embodiment of any of examples 5-10, wherein:
the first sources comprise sources of a first type; and the second sources comprise sources of second type different from the first type.

12. The embodiment of any of examples 5-11, wherein:
at least one of the first sources or the second sources comprises an air gun source.

13. The embodiment of any of examples 5-12, wherein:
the first sources comprise only one source; and
the second sources comprise only one source.

14. The embodiment of any of examples 5-12, wherein:
the first sources comprise only one source; and
the second sources comprise three sources.

15. The embodiment of any of examples 5-12, wherein:
the first sources comprise three sources; and
the second sources comprise only one source.

16. The embodiment of any of examples 5-12, wherein:
the first sources comprise three sources; and
the second sources comprise three sources.

17. Performing a marine seismic survey, comprising:
towing, with a vessel, a set of one or more streamers, wherein the streamers comprise one or more seismic sensors, wherein a forward-most one of the sensors disposed closest to a centerline of the vessel defines a front end of the streamers, wherein an aft-most one of the sensors disposed closest to the center line of the vessel defines a tail end of the streamers, and wherein a shortest one of the streamers defines a shortest streamer length;
towing, with the vessel, a set of one or more first sources disposed forward of the front end of the streamers by a distance not less than about 80% of the shortest streamer length;
towing, with the vessel, a set of one or more second sources disposed aft of the first sources and less than one shortest streamer length forward of the front end of the streamers; and
recording, in a non-transitory computer-readable medium, signals generated by the seismic sensors responsive activations of the first sources and the second sources.

18. The embodiment of example 17, wherein:
all of the streamers have a same length.

19. The embodiment of any of examples 17-18, wherein:
the shortest streamer length is about 100 meters.

20. The embodiment of any of examples 17-18, wherein:
the shortest streamer length is about 200 meters.

21. The embodiment of any of examples 17 or 19-20, wherein:
the streamers comprise a set of one or more longer streamers, each having a long offset streamer length, and a set of one or more shorter streamers, each having a near offset streamer length shorter than the long offset streamer length.

22. The embodiment of example 21, wherein:
wherein the long offset streamer length is at least twice that of the near offset streamer length.

23. The embodiment of any of examples 21-22, wherein:
the near offset streamer length is equal to the shortest streamer length.

24 The embodiment of any of examples 21-23, wherein:
at least one of the longer streamers is disposed between each pair of the shorter streamers.

25. The embodiment of any of examples 21-23, wherein:
the longer streamers and the shorter streamers are equal in number.

26. The embodiment of any of examples 21-25, wherein:
the long offset streamer length is about 200 meters.

27. The embodiment of any of examples 21-25, wherein:
the short offset streamer length is about 100 meters.

28. The embodiment of any of examples 21-27, wherein:
the set of one or more first sources is disposed at least one long offset streamer length forward of the front end of the streamers.

29. The embodiment of any of examples 17-28, wherein:
the first sources comprise sources of a first type; and
the second sources comprise sources of second type different from the first type.

30. The embodiment of any of examples 17-29, wherein:
the first sources comprise an air gun source type.

31. The embodiment of any of examples 17-30, wherein:
the first sources comprise only one source; and
the second sources comprise only one source.

32. The embodiment of any of examples 17-30, wherein:
the first sources comprise only one source; and
the second sources comprise three sources.

33. The embodiment of any of examples 17-30, wherein:
the first sources comprise three sources; and
the second sources comprise only one source.

34. The embodiment of any of examples 17-30, wherein:
the first sources comprise three sources; and
the second sources comprise three sources.

35. Apparatus configured to perform the embodiment of any of examples 1-34.

36. One or more non-transitory computer readable media containing instructions that, when executed by one or more computing devices, cause the performance of the embodiment of any of examples 1-34.

Multiple specific embodiments have been described above and in the appended claims. Such embodiments have been provided by way of example and illustration. Persons having skill in the art and having reference to this disclosure will perceive various utilitarian combinations, modifications and generalizations of the features and characteristics of the embodiments so described. For example, steps in methods described herein may generally be performed in any order, and some steps may be omitted, while other steps may be added, except where the context clearly indicates otherwise. Similarly, components in structures described herein may be arranged in different positions or locations than those described, and some components may be omitted, while other components may be added, except where the context clearly indicates otherwise. The scope of the disclosure is intended to include all such combinations, modifications, and generalizations as well as their equivalents.

What is claimed is:

1. A method of performing a marine seismic survey, comprising:
towing, with a vessel, a set of one or more streamers, wherein the streamers comprise one or more seismic sensors, wherein a forward-most one of the sensors disposed closest to a centerline of the vessel defines a front end of the streamers, and wherein an aft-most one of the sensors disposed closest to the center line of the vessel defines a tail end of the streamers;
towing, with the vessel, a set of one or more first sources disposed aft of the tail end of the streamers; and
recording, in a non-transitory computer-readable medium, signals generated by the seismic sensors responsive activations of the first sources.

2. The method of claim 1:
wherein a shortest one of the streamers defines a streamer length; and
further comprising towing, with the vessel, a set of one or more second sources disposed less than one streamer length forward of the front end of the streamers;
wherein the first sources are disposed aft of the tail end of the streamers by a distance not less than about 50% of the streamer length.

3. The method of claim 1:
wherein a shortest one of the streamers defines a streamer length;
wherein the first sources are disposed less than one streamer length aft of the tail end of the streamers; and
further comprising towing, with the vessel, a set of one or more second sources disposed aft of the tail end of the streamers by a distance not less than about 80% of the streamer length, and farther aft than the first sources.

4. The method of claim 3, wherein:
the first sources comprise sources of a first type; and
the second sources comprise sources of second type different from the first type.

5. The method of claim 4, wherein:
the second sources comprise an air gun source type.

6. The method of claim 3, wherein:
the first sources comprise three sources; and
the second sources comprise only one source.

7. The method of claim 1:
further comprising towing, with the vessel, a set of one or more second sources disposed forward of the streamers.

8. The method of claim 7, wherein:
the first sources comprise only one source; and
the second source comprise three sources.

9. The method of claim 7, wherein:
the first sources comprise three sources; and
the second source comprise three sources.

10. The method of claim 7, wherein:
an inline distance between the first sources and the tail end of the streamers is the same as an inline distance between the second sources and the front end of the streamers.

11. The method of claim 7, wherein:
at least one of the second sources follows a unique source line relative to source lines followed by the first sources, such that the second sources generate at least one common midpoint (“CMP”) line in the recorded signals that is not also generated by the first sources.

12. The method of claim 1:
further comprising towing, with the vessel, a set of one or more second sources disposed at one or more inline positions between the front end of the streamers and the tail end of the streamers, and at one or more crossline positions between a starboard-most one of the streamers and a port-most one of the streamers.

13. The method of claim 12, wherein:
the first sources comprise sources of a first type; and
the second sources comprise sources of second type different from the first type.

14. The method of claim 13, wherein:
the first sources comprise an air gun source type.

15. A method of performing a marine seismic survey, comprising:
towing, with a vessel, a set of one or more streamers, wherein the streamers comprise one or more seismic sensors, wherein a forward-most one of the sensors disposed closest to a centerline of the vessel defines a front end of the streamers, wherein an aft-most one of the sensors disposed closest to the center line of the vessel defines a tail end of the streamers, and wherein a shortest one of the streamers defines a shortest streamer length;
towing, with the vessel, a set of one or more first sources disposed forward of the front end of the streamers by a distance not less than about 80% of the shortest streamer length;
towing, with the vessel, a set of one or more second sources disposed aft of the first sources and less than one shortest streamer length forward of the front end of the streamers; and
recording, in a non-transitory computer-readable medium, signals generated by the seismic sensors responsive activations of the first sources and the second sources.

16. The method of claim 15, wherein:
the first sources comprise only one source; and
the second sources comprise three sources.

17. The method of claim 15, wherein:
the first sources comprise three sources; and
the second sources comprise three sources.

18. The method of claim 15, wherein:
the first sources comprise sources of a first type; and
the second sources comprise sources of second type different from the first type.

19. The method of claim 18, wherein:
the first sources comprise an air gun source type.

20. The method of claim 15, wherein:
the streamers comprise a set of one or more longer streamers, each having a long offset streamer length, and a set of one or more shorter streamers, each having a near offset streamer length shorter than the long offset streamer length.

21. The method of claim 20, wherein:
wherein the long offset streamer length is at least twice that of the near offset streamer length.

22. The method of claim 20, wherein:
at least one of the longer streamers is disposed between each pair of the shorter streamers.

23. The method of claim 20, wherein:
the long offset streamer length is about 200 meters.

24. The method of claim 20, wherein:
the set of one or more first sources is disposed at least one long offset streamer length forward of the front end of the streamers.

25. The method of claim 24, wherein:
the long offset streamer length is about 200 meters.
